(19) United States
(12) Patent Application Publication
(10) Pub. No.: US 2016/0225202 A1
(43) Pub. Date: Aug. 4, 2016

(54) METHOD OF DETECTING COMPONENTS IN MACHINE

(71) Applicant: Caterpillar Inc., Peoria, IL (US)

(72) Inventor: Lonny E. Johnson, Peoria, IL (US)

(73) Assignee: Caterpillar Inc., Peoria, IL (US)

(21) Appl. No.: 15/095,095

(22) Filed: Apr. 10, 2016

(51) Int. Cl. G07C 5/08

(52) U.S. Cl. CPC G07C 5/08

(57) ABSTRACT

A method of detecting components in a machine is provided. The method includes determining, by a control module, ignition state of an engine of the machine and identifying one or more electronic tags, each of the one or more electronic tags being associated with a component in the machine. The method includes obtaining information pertaining to one or more components of the machine via the one or more electronic tags. The method includes moving the machine from a first location to a second location. The method includes receiving, by the control module, information pertaining to replaced components from the electronic tags. The method includes analyzing, by the control module, the received information by comparing with a predefined set of information. The method includes displaying, by the control module, the information relating to the replaced components based on the comparison of the received information with the predefined set of information.

### TECHNICAL FIELD

The present disclosure relates to a method of detecting components in a machine, and more particularly relates to a method of detecting replaced components in the machine.

### BACKGROUND

Generally, a machine includes various components for performing different functions such as, a prime mover for driving engine of the machine, a power source for providing power to the machine, and the like. Such components may be associated with Radio-Frequency Identification (RFID) tags and barcode tags that are used in different applications. Also, validation of the barcode tags or the RFID tags occurs from a reader (e.g., a barcode reader or an RFID reader) associated with a detecting system to ensure proper identification of the component. The battery life of such barcode tags or the RFID tags may reduce when they are used for different applications like component sale, component tracking, component replacement, and the like.

U.S. Pat. No. 9,134,780 (the '780 patent) describes a computer that includes a communication unit for obtaining usage data and/or run-time data associated with the computer, at least one component communicatively coupled to the computer, and/or a vehicle on which the computer is mounted and from which the computer is configured to receive power. The computer further includes a processor configured to extrapolate out of the usage data and run-time data patterns associated with activities implemented by the computer and/or the at least one component and power states of the vehicle and create and store a profile of patterns; receive an indication that the vehicle has been toggled to one of an “ON” power state and an “OFF” power state; identify a pattern associated with the power state of the vehicle; and adapt a power state of the computer and/or the at least one component responsive to the indication and the pattern. However, the '780 patent does not disclose tracking of components of the machine.

### SUMMARY OF THE DISCLOSURE

in one embodiment of the present disclosure, a method of detecting components in a machine is described. The method includes determining, by a control module, ignition state of an engine of the machine. The ignition state includes at least one of an “ON” condition and an “OFF” condition of the engine. The method further includes identifying, by the control module, one or more electronic tags. Each of the one or more electronic tags is being associated with a component in the machine. The method further includes obtaining, by the control module, information pertaining to one or more components of the machine via the one or more electronic tags, when the ignition state of the engine is in the “ON” condition. The method further includes moving the machine from a first location to a second location. The first location is associated with a location at a service station and the second location is associated with a location at a threshold distance from the first location. The method further includes receiving, by the control module, information pertaining to replaced components from the electronic tags. The electronic tags communicate information to the control module for a predetermined time interval. The method further includes analyzing, by the control module, the received information by comparing with a predefined set of information. The predefined set of information includes information relating to non-replaced components in the machine. The method further includes displaying, by the control module, the information relating to the replaced components based on the comparison of the received information with the predefined set of information.

Other features and aspects of this disclosure will be apparent from the following description and the accompanying drawings.

### BRIEF DESCRIPTION OF THE DRAWINGS

FIG. 1 is perspective view of a machine, according to an embodiment of the present disclosure;

FIG. 2 is a diagrammatic view of a service station showing the machine of FIG. 1 in a first location;

FIG. 3 is a diagrammatic view of the machine of FIG. 1 in a second location; and

FIG. 4 is a flowchart of a method for detecting components in the machine.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claim.

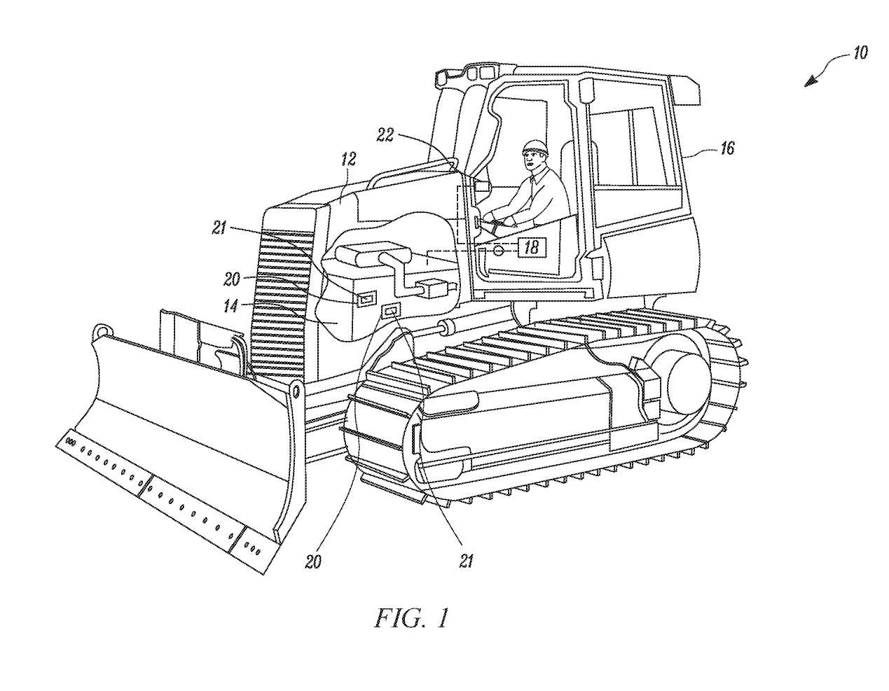

FIG. 1 illustrates a perspective view of a machine 10. The machine 10, may embody an earth moving machine, such as a dozer having traction devices, such as tracks, wheels, or the like. Alternatively, the machine 10 may be some other off-highway vehicle, such as an excavator, a backhoe, a loader, a motor grader, or any other machine. The machine 10 may be any of a manual, an automated or a semi-automated machine. In an example, the machine 10 may be adapted to perform operations in a worksite (not shown), for example, a mine site, a landfill, a quarry, a road site, a farm, a construction site, or any other similar type of worksite.

The machine 10 includes a frame 12 to support the various components of the machine 10 therein. The machine 10 includes an engine 14 adapted to power the traction devices of the machine 10, and other systems and assemblies in the machine 10. In an example, the engine 14 may be an internal combustion engine, such as a gasoline engine, a diesel engine, a gaseous fuel burning engine, or the like. The machine 10, as illustrated, further includes an operator cabin 16 from where an operator of the machine 10 may control the various systems and assemblies to perform the requisite operations. The engine 14 is adapted to be electronically controlled by an Electronic Control Module (ECM) (not shown) or a “Control Module” 18. The control module 18 determines an ignition state of the engine 14 of the machine 10. The ignition state of the engine 14 includes any one of an “ON” condition and an “OFF” condition of the engine 14. In an example, the control module 18 may utilize a plurality of sensors (not illustrated) for determining the operating parameters of the engine 14.

The control module 18 may be a processor including a single processing unit or a number of processing units, all of which may include multiple computing units. The explicit use of term ‘processor’ should not be construed to refer exclusively to hardware capable of executing a software application. Rather, in this example, the control module 18 may be implemented as one or more microprocessors, microcomputers, digital signal processor, central processing units, state machine, logic circuitries, and/or any device that is capable of manipulating signals based on operational instructions. Among the capabilities mentioned herein, the control module 18 may also be configured to receive, transmit, and execute computer-readable instructions.

The machine 10 may include other devices that may degrade or wear over a period of time and needs to be replaced after a prescribed time period for efficient working of the machine 10. These categories of devices are hereinafter collectively referred to as “machine components” 20 for the purpose of the present disclosure. The machine 10 may include one or more machine components 20 disposed therein. In the present disclosure, the machine components 20 include one or more electronic tags 21 associated with each of the components in the machine 10. The control module 18 is adapted to identify the one or more electronic tags 21 associated with the machine components 20 in the machine 10. In an example, the machine components 20 may include a variety of filters that are used to filter various kinds of fluids in the machine 10, for example, engine oil filters, transmission oil filters, exhaust gas filters, coolant filters, fuel filters, etc. In another example, the machine components 20 may also include other type of components, such as, engine oil pumps, transmission oil pumps, fuel pumps, coolant pumps, etc. which form cavities after a certain period of usage and thus needed to be replaced. In yet other examples, the machine components 20 may also include accessories and service components, such as, tires, meters and gauges, valves, supply lines, etc. which may need servicing and calibration after usage over a period of time. The machine components 20 may sometime need replacement for proper functioning of the machine 10.

In an example, the machine components 20 may be manufactured to include the one or more electronic tags 21. The one or more electronic tags 21 may be fixed to a body of the machine components 20. The one or more electronic tags 21 may be in the form of a tag embedded or attached to the body of the machine components 20. In an example, the one or more electronic tags 21 and its associated circuits may be powered by a battery (not shown) disposed in the machine components 20. In another example, the one or more electronic tags 21 may be powered by an energy harvester unit (not shown), such as, but not limited to, solar cell, piezo cell, and the like. In yet another example, the one or more electronic tags 21 may derive power from the engine 14 of the machine 10.

The machine 10 further includes a display unit 22 within the operator cabin 16. The display unit 22 is in communication with the control module 18 of the machine 10. In an example, the display unit 22 may employ any combination of display screens, touchscreens, light-emitting diodes (LEDs), speakers, and the like, to provide one or more of visual and/or audible indications about the machine components 20 installed in the machine 10. The display unit 22 is disposed in the operator cabin 16 that enables an operator to check information pertaining to the machine components 20 installed in the machine 10, such as for the manually operated machines. In an example, the display unit 22 may be in the form of a mobile device, such as a smartphone, a tablet, personal digital assistant (PDA), or the like which enables the operator to remotely check information pertaining to the machine components 20 installed in the machine 10, such as for the automatically operated machines. In another example, the display unit 22 may be disposed in a remote location from where the service personnel may check the information pertaining to the machine components 20 installed in the machine 10.

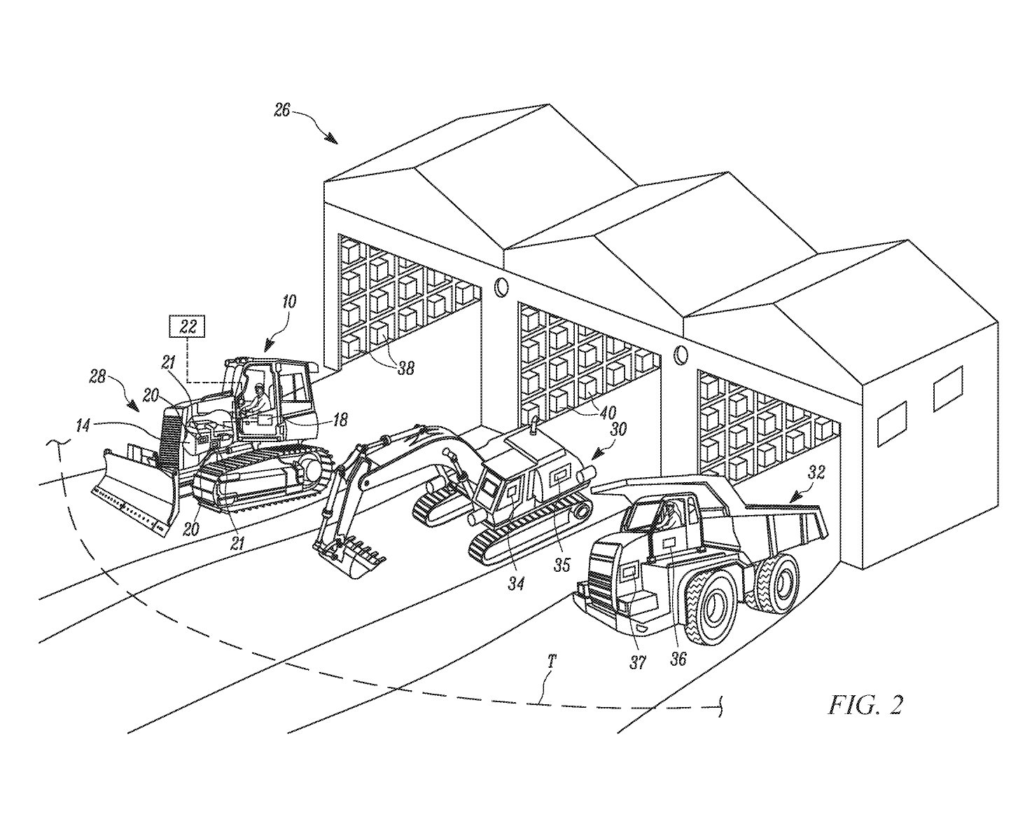

FIG. 2 is a diagrammatic depiction of a service station 26 showing the machine 10 of FIG. 1 in a first location 28. The service station 26 may accommodate multiple machines among which the present disclosure illustrates a first machine 30 and a second machine 32, as shown in FIG. 2. The first machine 30 and the second machine 32 are adapted to perform various earth moving operations. In the present disclosure, the first machine 30 is excavator-type earthmoving or logging machine and the second machine 32 is a large mining truck.

The first machine 30 and the second machine 32 may further include a first control module 34 and a second control module 36, respectively. The first control module 34 may be programmed for controlling various operations of the first machine 30 and an implement system of the first machine 30 based on an input command received from an operator of the first machine 30. The first machine 30 may includes various components with one or more electronic tags 35 associated with each component of the first machine 30. The second control module 36 may be programmed for controlling various operations of the second machine 32 and an implement system of the second machine 32 based on an input command received from an operator of the second machine 32. The second machine 32 may include various components with one or more electronic tags 37 associated with each component of the second machine 32.

Although the one or more electronic tags 21 of the machine 10 is collectively referred by the reference numeral 21, it will be understood by a person skilled in the art that each of the electronic tags may be designated with a unique code. In an example, the unique code may be a combination of alphabets and numbers. In an example, the one or more electronic tags 35 of the first machine 30 and the one or more electronic tags 37 of the second machine 32 may be designated with the unique code.

The service station 26 is embodied as a repair garage. In the illustrated embodiment, the service station 26 is referred to as an automobile repair or component replacement station. The automobile repair or replacement station may be a location where the machine 10, the first machine 30, and the second machine 32 may be repaired. The service station 26 may further include new machine components 38 and used machine components 40 that may be installed on the machine 10, the first machine 30, and the second machine 32.

As shown in FIG. 2, when the machine 10 is in a first location 28, the control module 18 of the machine 10 is configured to identify the one or more electronic tags 21, 35 and 37, respectively, associated with components of the machine 10, the first machine 30, and the second machine 32 within a threshold distance “T”. The first location 28 of the machine 10 as used herein refers to a position of the machine within the threshold distance ‘T’ at the service station 26. The control module 18 of the machine 10 is further configured to obtain information pertaining to one or more components within the threshold distance “T” via the one or more electronic tags 21, 35 and 37 within the threshold distance “T”. The threshold distance “T” is referred to as a maximum distance within which the control module 18 of the machine 10 may identify information pertaining to the components in the vicinity of the service station 26. The display unit 22 of the machine 10 is configured to display the machine components 20 and components of the first machine 30 and the second machine 32 identified at the service station 26 based on signals received from each of the machines 10, 30, and 32, respectively, present at the service station 26. The displayed components include both replaced components of the machine 10 and other machine components of the first machine 30 and the second machine 32 present at the service station 26.

Based on the components thus identified, the display unit 22 of the machine 10 displays information pertaining to the components of the machine 10, the first machine 30, the second machine 32, and the service station 26, Such displaying of the information by the display unit 22 of the machine 10 may be based on presence of the components within the threshold distance “T”. The control module 18 of the machine 10 obtains information pertaining to the components only when the ignition state of the engine 14, the first machine 30, and the second machine 32 is “ON” condition.

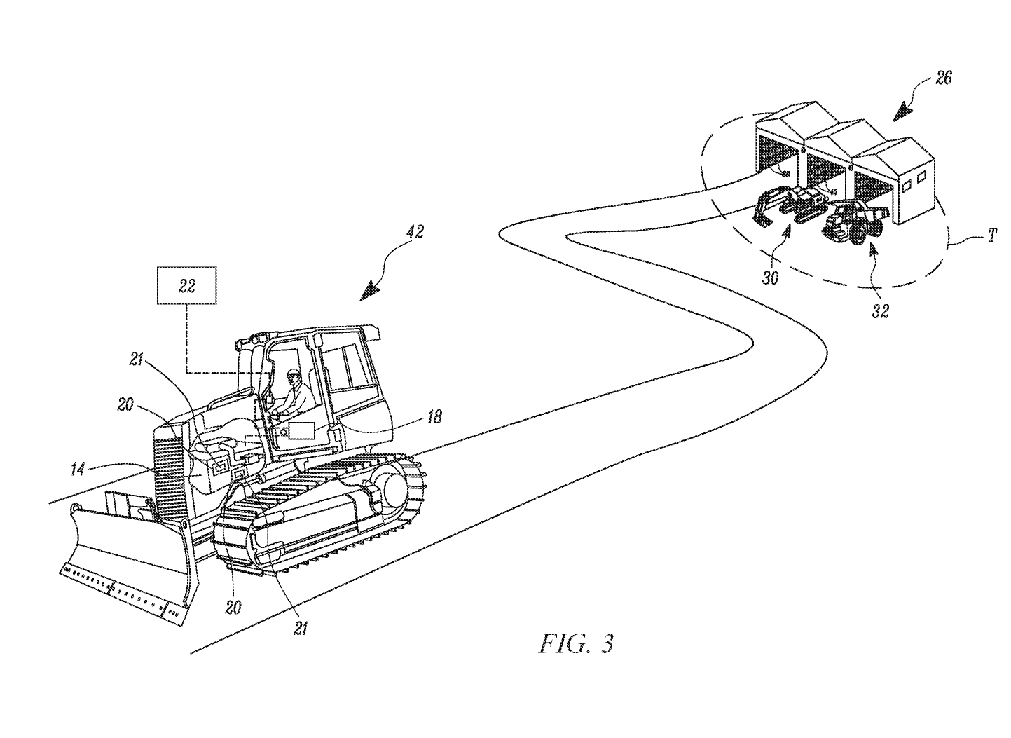

FIG. 3 is a diagrammatic depiction of the machine 10 of FIG. 1 in a second location 42. As shown in FIG. 3, the control module 18 of the machine 10 is configured to identify the one or more electronic tags 21 associated with the machine components 20 of the machine 10 when the machine 10 is in the second location 42. The second location 42 of the machine 10 is a position associated with a location at a predefined distance from the first location 28 of the machine 10. The predefined distance may be understood as a minimum distance that needs to be traversed by the machine 10 for not being covered within the threshold distance “T”. The control module 18 of the machine 10 is further configured to receive information pertaining to replaced components of the machine 10 from the one or more electronic tags 21 associated with each replaced component. The control module 18 is configured to receive information pertaining to the replaced components of the machine 10 from the one or more electronic tags 21, for a predetermined time interval. The predetermined time interval may be understood as a minimum time required for the machine 10 to move out of the threshold distance “T” with respect to the service station 26. In an example, the predetermined time interval may be about 10 minutes when the ignition state of the engine 14 is in the “ON” condition.

The information received from the one or more electronic tags 21 is analyzed and compared with a predefined set of information by the control module 18 of the machine 10. The predefined set of information includes information pertaining to non-replaced components of the machine 10. The predefined set of information may be pre-fed to the control module 18 of the machine 10. In an example, the predefined set of information may relate to components present within the threshold distance “T” with respect to the service station 26. Based on the comparison, the display unit 22 of the machine 10 is configured to display information pertaining to the replaced components of the machine 10, Owing to the distance traversed by the machine 10 beyond the threshold distance “T”, components present within the threshold distance “T” may not be displayed to the operator.

Although the present disclosure herein describes detection of components in the machine 10, it should be understood that the devices and methods aiding such detection are not limited to the machine 10. Rather, the devices and methods are considered as exemplary arrangements for the purpose of detecting any replacement in the machine components 20 and indicating such details to the operator of the machine 10. However, it will be appreciated by the person skilled in the art that the methods described herein may be implemented with respected to the first machine 30 and the second machine 32.

### INDUSTRIAL APPLICABILITY

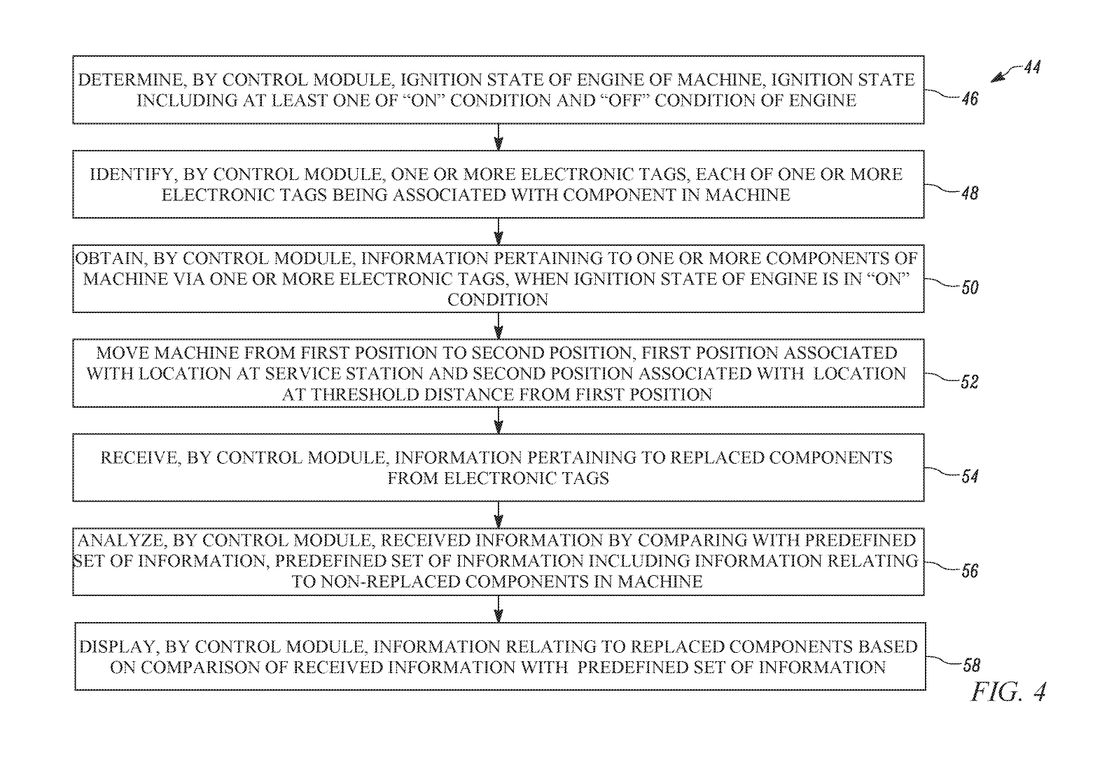

The present disclosure relates to a method 44 of detecting components in the machine 10. FIG. 4 is a flow chart of the method 44 of detecting components in the machine 10. The steps in which the method 44 is described are not intended to be construed as a limitation, and any number of steps can be combined in any order to implement the method 44. Further, the method 44 may be implemented in any suitable hardware, such that the hardware employed can perform the steps of the method 44 readily and on a real-time basis. For example, the method 44 may be implemented by the control module 18 of the machine 10.

At step 46, the method 44 includes determining, by the control module 18, ignition state of the engine 14 of the machine 10, the ignition state includes at least one of the “ON” condition and the “OFF” condition of the engine 14. The control module 18 determines the state of the engine 14 based on the operating parameters of the engine 14. In an example, the control module 18 may identify the engine speed, the oil pressure, and the oil temperature of the engine 14. At step 48, the method 44 includes identifying, by the control module 18, the one or more electronic tags 21, each of the one or more electronic tags 21 is being associated with the machine components 20 in the machine 10.

At step 50, the method 44 includes obtaining, by the control module 18, information pertaining to the machine components 20 of the machine 10 via. the one or more electronic tags 21, when the ignition state of the engine 14 is in the “ON” condition. Further, at step 52, the method 44 includes moving the machine 10 from the first location 28 to the second location 42. The first location 28 of the machine 10 is associated with the location at the service station 26. The second location 42 of the machine 10 is associated with the location at the threshold distance “T” from the first location 28 of the machine 10.

At step 54, the method 44 includes receiving, by the control module 18, information pertaining to replaced components from the electronic tags 21. The electronic tags 21 tend to communicate information to the control module 18 for the predetermined time interval, Further, at step 56, the method 44 includes analyzing, by the control module 18, the received information by comparing with the predefined set of information. The predefined set of information includes information relating to non-replaced components in the machine 10. At step 58, the method 44 includes displaying, by the control module 18, the information relating to the replaced components based on the comparison of the received information with the predefined set of information.

Owing to such analysis and display of the information relating to the replaced components, the method 44 ensures proper identification of the machine components 20 in the machine 10 with the use of the one or more electronic tags 21 of the machine 10. The operator of the machine 10 need not wait at the service station 26 to ensure proper tracking of the machine components 20, as the control module 18 tracks and stores the information relating to the replaced components on a real time basis. Further, the control module 18 of the machine 10 communicates with the display unit 22 to display information pertaining to the replaced components of the machine 10, when the machine 10 is in the second location 42 beyond the threshold distance “T”. The method 44 of present disclosure enables increasing battery life of the one or more electronic tags 21, The battery life of the one or more electronic tags 21 is extended by reducing broadcasting rate of the information pertaining to the replaced components to the control module 18 of the machine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of detecting components in a machine, the method comprising:
determining, by a control module, ignition state of an engine of the machine, the ignition state including at least one of an “ON” condition and an “OFF” condition of the engine;
identifying, by the control module, one or more electronic tags, each of the one or more electronic tags being associated with a component in the machine;
obtaining, by the control module, information pertaining to one or more components of the machine via the one or more electronic tags, when the ignition state of the engine is in the “ON” condition;
moving the machine from a first location to a second location, the first location associated with a location at a service station and the second location associated with a location at a threshold distance from the first location;
receiving, by the control module, information pertaining to replaced components from the electronic tags, wherein the electronic tags communicate information to the control module for a predetermined. time interval;
analyzing, by the control module, the received information by comparing with a predefined set of information, the predefined set of information including information relating to non-replaced components in the machine; and
displaying, by the control module, the information relating to the replaced components based on the comparison of the received information with the predefined set of information.
